(19) United States
(12) Patent Application Publication
(10) Pub. No.: US 2014/0137114 A1
(43) Pub. Date: May 15, 2014

(54) VIRTUAL MACHINE TEMPLATE CREATION BASED ON DATA FEEDS

(71) Applicant: International Business Machines Corporation, Armonk, NY (US)

(72) Inventors: Dirk Bolte, Birkenfeld (DE); Daniel Ketcham, San Jose, CA (US); Thomas Pohl, Boeblingen (DE); Martin Strobel, Boeblingen (DE); Martin Troester, Boeblingen (DE)

(73) Assignee: International Business Machines Corporation, Armonk, NY (US)

(21) Appl. No.: 14/101,595

(22) Filed: Dec. 10, 2013

Related U.S. Application Data
(63) Continuation of application No. 14/077,645, filed on Nov. 12, 2013.

(30) Foreign Application Priority Data
Nov. 15, 2012 (GB) 1220537.3

(51) Int. Cl. G06F 9/455

(52) U.S. Cl. CPC G06F 9/45533
USPC 718/1

(57) ABSTRACT

Data that includes information about an application is retrieved from a data feed. It is determined that the data from the data feed indicates that the application has been updated. In response to a determination that the data from the data feed indicates that the application has been updated, data descriptive of the application is extracted from the data from the data feed. One or more instructions for installing the application are determined based, at least in part, on the data descriptive of the application. In response to determination of the one or more instructions for installing the application, a first virtual machine skeleton that includes the one or more instructions for installing the application is generated.

### RELATED APPLICATIONS

This application claims the priority benefit of U.S. patent application Ser. No. 14/077,645, filed Nov 12, 2013, which claims the benefit of United Kingdom Patent Application No. 1220537.3, filed Nov. 15, 2012.

### BACKGROUND

Computer virtualization is one of the more important technologies for various-sized companies. Computer virtualization can increase the computational efficiency and flexibility of a computing hardware platform.

### SUMMARY

In at least one aspect, the present inventive subject matter relates to a computer implemented method to create virtual machine templates in a system, the system hosting one or more applications to be executed on virtual machines of the system.

The method comprises automatically retrieving feed data from a server providing information on an application of the one or more applications. The retrieving may be remotely performed by interfacing with an API provided by the server. The feed data may be a file of a plurality of types and/or in any arbitrary form. For example, the feed data may comprise an RSS feed file and/or an email message.

The method further comprises evaluating the content of the feed file for determining data indicative of an update in the application. For example, the evaluating can comprise parsing the content of the feed file, extracting data indicative of the version of the application, comparing the version of the application with the version of the application being used in the system, and determining whether the data is indicative of an update based on the comparison.

The method further comprises, in response to a determination that the data is indicative of the update in the application, extracting from the feed file descriptive data of the application and determining installation data for installing the application in the system. For example, the installation data may indicate additional installation instructions to the installation instructions of the application before update. The additional installation instructions may be used for installing the updated application.

The method further comprises providing a plurality of virtual machine skeletons, wherein a skeleton defines the hardware and software configuration data of a virtual machine of the virtual machines. Each virtual machine skeleton may define the hardware and software configuration compatible with the virtual machine that may run at least one application of the one or more applications in the system. Also, more than one virtual machine skeleton may define the hardware and software configuration for running the same application.

The method further comprises selecting from the plurality of virtual machine skeletons a set of virtual machine skeletons indicative of at least part of the descriptive data.

The method further comprises creating for each virtual machine skeleton of the set of virtual machine skeletons a virtual machine template using the descriptive data, the installation data and the virtual machine skeleton.

Automatically creating updated virtual machine templates in the system using RSS feeds may reduce the amount of manual interactions required for that procedure. This is in contrast to conventional systems where manual interventions are required for such updates.

Embodiments may synchronize the update of the virtual machine templates to the application updates provided by the application providers. This may increase the availability of updated virtual machine templates in timely manner.

A user of the system, such as a cloud provider in a cloud computing environment, may no longer require insight into how templates are to be created and/or updated since it is performed automatically by the system.

The user of the system may be provided multiple virtual machine templates using the set of virtual machine skeletons for the same application the user intends to run on a virtual machine. This may provide multiple choices to the user such that the user can select a virtual machine template suitable for his or her use. Another advantage may be that multiple virtual machine templates may be automatically created on availability of a new application. As an example, an update of IBM® DB2® software leads to the creation of multiple virtual machine templates. One may consist of a 64 bit Red Hat® Linux operating system with the IBM DB2 installed; another virtual machine template may consist of a 32 bit Microsoft Windows® operating system including IBM DB2 and IBM Websphere® application server.

In some embodiments, the feed data comprises a feed file being generated by a Rich Site Summary, RSS, Server, the server comprising the RSS server.

In some embodiments, providing the plurality of virtual machine skeletons comprises providing a data structure having one or more entries, each entry representing a virtual machine skeleton, each entry comprising a virtual machine skeleton identifier and hardware and software configuration data to use for providing an application to a virtual machine, wherein the selecting comprises: reading the data structure; and determining the virtual machine skeleton identifier associated with the hardware and software configuration data indicative of the part of the descriptive data. For example, the data structure may be a table stored in a memory of the system. This may accelerate the process of creation of the virtual machine templates. The virtual machine skeleton identifier may be for example an entry index identifying the entry representing the virtual machine skeleton. Determining the virtual machine skeleton identifier may comprise for each entry in the data structure: comparing the hardware and software configuration data of the entry with the descriptive data, and selecting the virtual machine skeleton identifier of the entry in case said hardware and software configuration data is indicative of the part of the descriptive data.

In some embodiments, the descriptive data comprises the name of the application, wherein the selecting comprises selecting the set of virtual machine skeletons having hardware and software configuration data indicative of the name of the application.

According to one embodiment, the provision of the plurality of virtual machine skeletons comprises, for each virtual machine skeleton: determining the hardware and software configuration data to use for providing an application of the one or more applications to a virtual machine of the virtual machines; creating a computer file containing the hardware and software configuration data; and storing the computer file in association with a virtual machine skeleton identifier in the system.

The computer file may be of a plurality of types. This may provide several options to create multiple virtual machine templates for the same application. For example, the computer file may be a kickstart file.

In some embodiments, the provision of the plurality of virtual machine skeletons comprises determining each virtual machine skeleton based on a predefined operating condition of the system.

The term operating condition as used herein refers to any operator adjustable configuration of the system that influences the behavior of the system during operation. For example, the operating condition of the system may be received from a user of the system. This may allow the user to define his own whishes or requirements suitable for his application and that should be satisfied by the virtual machine that he wanted to run on the system.

In some embodiments, the operating condition may be received from an administrator of the system which may take into account the system configuration and capabilities to run the applications. This may avoid a system failure or congestion that may be caused by a non-adequate hardware and software configuration in one of the skeletons.

In case the user of the system is a cloud provider (e.g. the system is installed in the cloud provider's system), determining each virtual machine skeleton may be based on a service level agreement (SLA), wherein the SLA comprises one or more service level objectives (SLO), wherein one or more service level objectives comprises said predefined conditions.

The computing system may provide virtual machine templates (created out of the virtual machine skeletons) with a predefined quality.

In some embodiments, the operating condition comprises: the execution time of the application is smaller than a preset maximum execution time value; a secure installation of the application is performed; and/or a predefined language is used.

The implementation of such condition may be performed, for example, as in the following example: The hardware and software configuration data can be indicative of a requirement of one or more resources of the system.

The conditions may be translated into a set of requirements on the resources (e.g. hardware and software) that may be provided to a virtual machine that can be used by the user of the system. This may result in a specific combination of resources that may satisfy the conditions. For example, for a user requesting a short execution time of the application, the hardware and software configuration data may indicate more CPU and memory size to be allocated to the VM, in comparison to a user that may only request a specific language and/or secure installation of the application on the VM that he is using.

In some embodiments, the resources comprise: number of CPUs; memory size; hard disk space; firewall settings; and/or language settings.

In some embodiments, the creating comprises: using the hardware and software configuration data and the installation data to determine an operating system to run with a virtual machine of the virtual machines; generating a provisioning installation script using the hardware and software configuration data, the installation data and the operating system; and executing the provisioning installation script.

After being created, a virtual machine template may be used repeatedly to create virtual machines using the same settings of the created virtual machine template and thus having access to the updated version of the application.

In some embodiments, the creating further comprises determining virtual machine templates previously created in the system to provide a previous version of the application and deleting determined virtual machine templates.

In some embodiments, the installation data comprises a dependency map for the application, the dependency map encoding a dependency relationship between the application and packages used in execution of the application. For example, the dependencies may be used to determine the appropriate operating system as they may give a list of packages that they may be used only with a specific operating system.

In at least one aspect, the inventive subject matter relates to a computer-readable medium, comprising computer-readable program code embodied therewith which, when executed by a processor, cause the processor to execute a method according to any one of the previous embodiments.

In at least one aspect the inventive subject matter relates to a computer system to create virtual machine templates, the computer system hosting one or more applications to be executed on virtual machines of the computer system, the computer system comprising a memory and a processor for controlling the computer system, the memory comprising a control module for storing machine executable instructions wherein execution of the machine executable instructions causes the processor to: automatically retrieve feed data from a server providing information on an application of the one or more applications; evaluate the content of the feed data for determining data indicative of an update in the application; in response to a determination that the data is indicative of the update in the application, extract descriptive data of the application from the feed data and determine installation data for installing the application in the system; provide a plurality of virtual machine skeletons, wherein a skeleton defines the hardware and software configuration data of a virtual machine of the virtual machines; select from the plurality of virtual machine skeletons a set of virtual machine skeletons indicative of at least part of the descriptive data; and create for each virtual machine skeleton of the set of virtual machine skeletons a virtual machine template using the descriptive data, the installation data and the virtual machine skeleton.

In at least one aspect, the inventive subject matter relates to a control module to create virtual machine templates in a system, the system hosting one or more applications to be executed on virtual machines of the system, the control module being adapted to: automatically retrieve feed data from a server providing information on an application of the one or more applications; evaluate the content of the feed data for determining data indicative of an update in the application; in response to a determination that the data is indicative of the update in the application, extract from the feed data descriptive data of the application and determine installation data for installing the application in the system; provide a plurality of virtual machine skeletons, wherein a skeleton defines the hardware and software configuration data of a virtual machine of the virtual machines; select from the plurality of virtual machine skeletons a set of virtual machine skeletons indicative of at least part of the descriptive data; and create for each virtual machine skeleton of the set of virtual machine skeletons a virtual machine template using the descriptive data, the installation data and the virtual machine skeleton.

A ‘computer-readable storage medium’ as used herein encompasses any tangible storage medium which may store instructions which are executable by a processor of a computing device. The computer-readable storage medium may be referred to as a computer-readable non-transitory storage medium. The computer-readable storage medium may also be referred to as a tangible computer readable medium. In some embodiments, a computer-readable storage medium may also be able to store data which is able to be accessed by the processor of the computing device. Examples of computer-readable storage media include, but are not limited to: a floppy disk, a magnetic hard disk drive, a solid state hard disk, flash memory, a USB thumb drive, Random Access Memory (RAM), Read Only Memory (ROM), an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example a data may be retrieved over a modem, over the internet, or over a local area network. Computer executable code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer executable code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

‘Computer memory’ or ‘memory’ is an example of a computer-readable storage medium. Computer memory is any memory which is directly accessible to a processor. ‘Computer storage’ or ‘storage’ is a further example of a computer-readable storage medium. Computer storage is any non-volatile computer-readable storage medium. In some embodiments computer storage may also be computer memory or vice versa.

A ‘processor’ as used herein encompasses an electronic component which is able to execute a program or machine executable instruction or computer executable code. References to the computing device comprising “a processor” should be interpreted as possibly containing more than one processor or processing core. The processor may for instance be a multi-core processor. A processor may also refer to a collection of processors within a single computer system or distributed amongst multiple computer systems. The term computing device should also be interpreted to possibly refer to a collection or network of computing devices each comprising a processor or processors. The computer executable code may be executed by multiple processors that may be within the same computing device or which may even be distributed across multiple computing devices.

Computer executable code may comprise machine executable instructions or a program which causes a processor to perform at least one aspect of the present inventive subject matter. Computer executable code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages and compiled into machine executable instructions. In some instances the computer executable code may be in the form of a high level language or in a pre-compiled form and be used in conjunction with an interpreter which generates the machine executable instructions on the fly.

The computer executable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block or a portion of the blocks of the flowchart, illustrations, and/or block diagrams, can be implemented by computer program instructions in form of computer executable code when applicable. It is further understood that, when not mutually exclusive, combinations of blocks in different flowcharts, illustrations, and/or block diagrams may be combined. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The “virtual machine template” as used herein refers to a pre-configured virtual machine image offered to users (e.g. in a cloud) and can be used repeatedly to create virtual machines. On usage, the “virtual machine template” is either copied or a copy on write layer is created to preserve the template from modification. In some embodiments, the virtual machine template may also refer to an installation script that automatically installs and configures a virtual machine image on usage.

The term “cloud computing” as used herein may refer to a model for enabling ubiquitous, convenient, on-demand network access to a shared pool of configurable computing resources (e.g., networks, servers, storage, applications, and services) that can be rapidly provisioned and released with minimal management effort or service provider interaction.

As will be appreciated by one skilled in the art, aspects of the present inventive subject matter may be embodied as an apparatus, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer executable code embodied thereon.

It is understood that one or more of the aforementioned embodiments may be combined as long as the combined embodiments are not mutually exclusive.

### BRIEF DESCRIPTION OF THE DRAWINGS

In the following, preferred embodiments of the inventive subject matter will be described in greater detail by way of example only making reference to the drawings in which:

FIG. 1 illustrates an example system architecture operable to execute a process for creating virtual machine templates in a cloud computing environment;

FIG. 2 illustrates an example system architecture for the execution of operations for creating virtual machine templates; and

FIG. 3 is an example flowchart depicting operations for creating virtual machine templates.

### DESCRIPTION OF EMBODIMENT(S)

In the following, like numbered elements in the figures either designate similar elements or designate elements that perform an equivalent function. Elements which have been discussed previously will not necessarily be discussed in later figures if the function is equivalent.

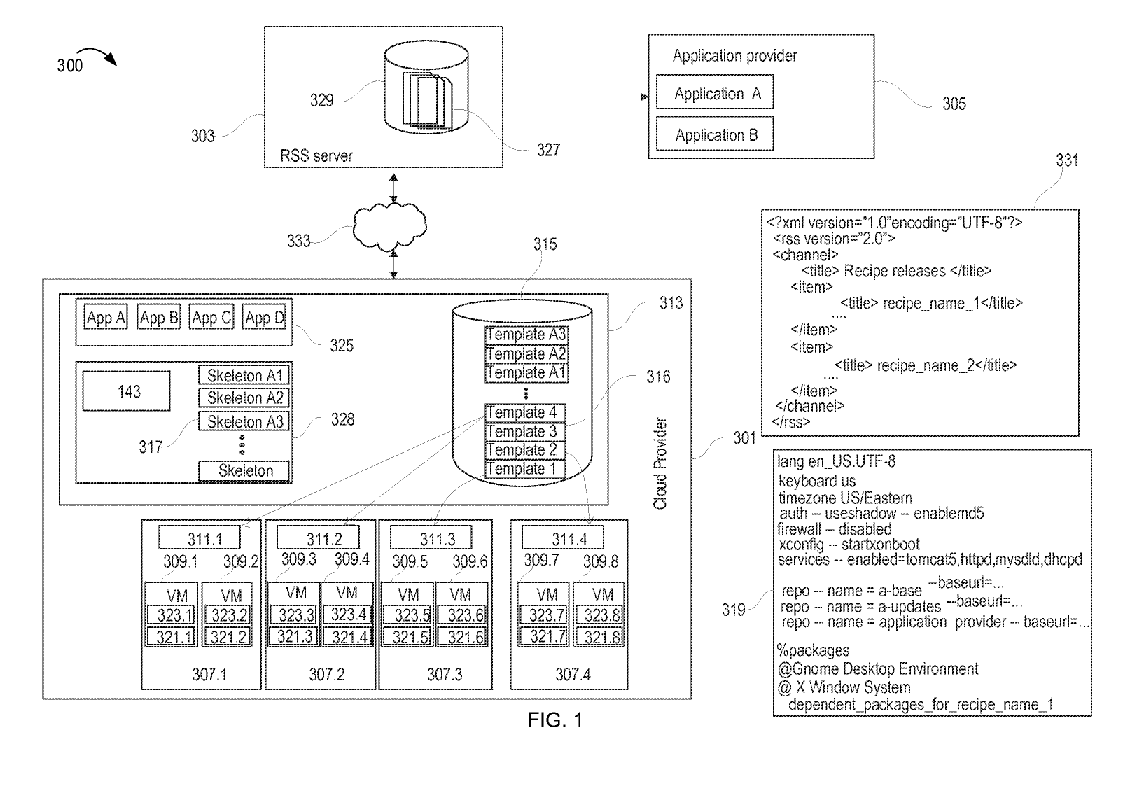

FIG. 1 depicts system architecture 300 operable to execute a process for creating virtual machine templates in a cloud computing environment. In some embodiments, the process or the inventive subject matter may be executed in other distributed computing systems such as grid computing system and cluster computing systems and computing systems supporting virtualization software.

The system 300 comprises a cloud provider 301, an RSS server 303 and an application provider 305. The cloud provider 301 provides physical machines 307.1, 307.2, 307.3 and 307.4 which are communicatively coupled via a network to shared resources (not shown) such as a storage server providing remote hard disks and/or network. Each of physical machines 307.1, 307.2, 307.3 and 307.4 may comprise a hypervisor 311.1-311.4, respectively. Each hypervisor may create one or more virtual machines, for example, virtual machines 309.1 and 309.2 on physical machine 307.1, and virtual machines 309.5 and 309.6 on physical machine 307.3. Each hypervisor 311 may enable its virtual machines to share resources. For that, each hypervisor 311 may transform physical resources into virtual resources so that the virtual machines 309 can share the same physical resources. For example, the hypervisor 311 may enable each virtual machine 309 to have dedicated or shared processors and I/O, and dedicated memory. Each of the virtual machines 309 comprises an operating system 321 and one or more applications 323 running on the operating system 321.

The cloud provider 301 further comprises a computer server 313. The computer server 313 comprises a library 315 including virtual machine templates 316, and a memory 328 for storing the control module 143. The control module 143 may provide a plurality of virtual machines skeletons 317 defining hardware and configuration data of a virtual machine. This may be done by creating a computer file for each of the virtual machine skeletons 317 (or for a plurality of them) containing the respective hardware and software configuration data. The creation may be based on a predefined operating condition of the system 300. The computer files may be stored in association with a virtual machine skeleton identifier in the memory 328. An example of virtual machine skeleton content 319 is also shown in FIG. 1. The virtual machine skeleton content 319 regulates as operating conditions, for example, the language, firewall settings that may be associated with an application.

The computer server 313 may comprise one or more applications 325. In addition to the applications 325, the computer server 313 may further comprise mapping data stored in a database (not shown). The mapping data is indicative of dependencies between each of the one or more applications and/or a combination thereof, and associated installation dependencies, hardware requirements, operating system, virtual machine template, and other application descriptive parameters.

The computer server 313 may manage the hypervisors 311.1-311.4. For example, the computer server 313 may send a request to a hypervisor to create a virtual machine based on a client request. Alternatively, the computer server 313 may automatically send the request, for example, after the creation of updated virtual machine templates as described below. The request may be indicative of one of the virtual machine templates 316. In response to the request, the hypervisor 311 may access the library 315 to read the one virtual machine template and to create the virtual machine using that virtual machine template. For example, hypervisor 311.4 uses virtual machine template 2 to create the virtual machine 309.8, and hypervisors 311.1 and 311.2 use the same virtual machine template 4 to create the virtual machines 309.1 and 309.3 respectively.

The computer server 313 is shown as a single component but the computer server 313 may also be implemented on several components such that the functions of computer server 313 may be divided or allocated among a plurality of servers.

The RSS server 303 may be connected to the application provider 305 directly or via a network. The application provider 305 may be, for example, a computer server. The application provider 305 may provide a plurality of applications, such as applications A and B. For example, the application A may be part of the one or more applications 325. The application A (e.g. 323.2) may be running on the virtual machine 309.2. For example, the application A may be updated by the application provider 305 after being used by the cloud provider 301. The updated application A has, for example, a new version number compared to the application A being in the computer server 313. An application may be for example an operating system and/or a software application. The RSS server 303 may provide information on the applications A and B. The information may be contained in one or more feed files 327. The feed files 327 may be stored in a database 329 of the RSS server 303. An example of an RSS feed file is shown in FIG. 1 as an XML file 331 containing application version numbers, for example.

The computer server 313 may be connected to the RSS server 303 via a network 333, which may be a public network, such as the Internet, a private network, such as a wide area network (WAN), or a combination thereof. The computer server 313 may access content of the feed files 327 of the RSS server 303. For example, the control module 143 may automatically retrieve the content of the feed files 327 from the RSS server 303, and may evaluate that content for determining data indicative of an update in the application A. For example, for determining data indicative of an update, the control module 143 may detect and read the version number of the updated application A and may compare the version number with the mapping data stored in the database to lookup configurations, dependencies and virtual machine templates associated with the application A previously installed in the server 313. Alternatively, the control module 143 may search and detect a keyword such as “New Version” indicative of an update of the application A. Further, the control module 143 may determine installation data for installing the application in the system 300. The installation data may be indicative of additional installation operations to the installation operations allowing for running and/or installation of the non-updated application A 323.2 in the virtual machine 309.2.

The control module 143 may select from the plurality of virtual machines skeletons 317 a set of virtual machine skeletons having hardware and software configuration data indicative of the name of the application A. For example, the control module 143 may select the skeletons A1, A2 and A3. The three skeletons define different hardware and software configuration data for the same application A. For example, the virtual machine skeletons A1, A2 and A3 may be provided based on different operating conditions. The operating condition may be, for example, that a predefined language is to be used and/or a secure installation of the application A is to be performed. For that, the language and firewall settings may be set accordingly in the virtual machine skeleton.

The installation data may further comprise a dependency map for the application A. The dependency map encodes a dependency relationship between the application A and packages used in execution of the application A.

The control module 143 may use the hardware and software configuration data of the set of virtual machine skeletons and the installation data to determine an operating system to run with a virtual machine, e.g. 309.2 of the virtual machines 309. Furthermore, the control module 143 may generate a provisioning installation script using the hardware and software configuration data, the installation data and the operating system. After executing of the provisioning installation script, virtual machine template A1, template A2 and template A3 are created and stored in the library 315.

The control module 143 may determine virtual machine templates which are previously created for the application A (or, in case of copy on write, images no longer in use) and may delete them as they are outdated.

Furthermore, a request may be triggered by a client of the system 300. The hypervisor 311.1 may select one of the virtual machine templates A1, A2 and A3 based on the request, and replace and/or create a new virtual machine running the updated application A using the selected virtual machine template. The request may be indicative of the language to be used e.g. English. The selected virtual machine template may have language setting set to English.

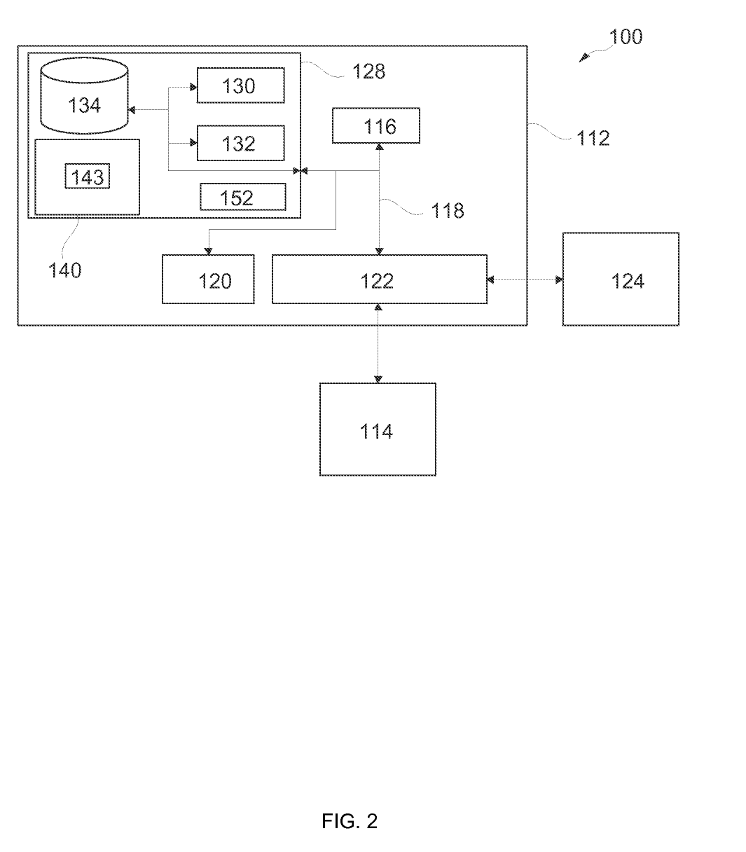

FIG. 2 shows a schematic of an example computing system. Computing system 100 is only one example of a suitable computing system and is not intended to suggest any limitation as to the scope of use or functionality of the inventive subject matter described herein.

In computing system 100 there is a computer system/server 112, which is operational with numerous other general purpose or special purpose computing system environments or configurations. The computer server 112 may be the computer server 313 described above. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor based systems, set top boxes, programmable consumer electronics, network PCs, minicomputer systems, mainframe computer systems, and distributed Cloud computing environments that include any of the above systems or devices, and the like.

Computer system/server 112 may be described in the general context of computer system-executable instructions, such as program modules, being executed by a computer system. Generally, program modules include routines, programs, objects, components, logic, data structures, and so on that perform particular tasks or implement particular abstract data types. The example computer system/server 112 may be practiced in distributed Cloud computing environments where tasks are performed by remote processing devices that are linked through a communications network. In a distributed Cloud computing environment, program modules may be located in both local and remote computer system storage media including memory storage devices.

As shown in FIG. 2, computer system/server 112 in computing system 100 is shown in the form of a general-purpose computing device. The components of computer system/server 112 may include, but are not limited to, one or more processors or processing units 116, a system memory 128, and a bus 118 that couples various system components including system memory 128 with processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer readable media. Such computer readable media may be any available media that is accessible by computer system/server 112, including both volatile and non-volatile media, removable and non-removable media, etc.

System memory 128 may include computer readable media in the form of volatile memory, such as random access memory (RAM) and/or cache memory (not shown). Computer system/server 112 may further include other removable/non-removable, volatile/non-volatile computer readable storage media. By way of example only, a storage system 134 may be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 118 by one or more data media interfaces. As will be further depicted and described below, memory 128 may include at least one program product having a set (e.g., at least one) of program modules that are configured to carry out the functions of the inventive subject matter.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interface(s) 122. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples include, but are not limited to: microcode, device drivers, redundant processing units, external disk drive arrays, RAID systems, tape drives, and data archival storage systems, etc.

System memory 128 is further shown as containing one or more virtual machine skeleton files 152.

Program/utility 140 having a set (at least one) of program modules may be stored in memory 128 by way of example, and not limitation, as well as an operating system, one or more software application programs, other program modules, and program data. Each of the operating system, one or more software application programs, other program modules, and program data or some combination thereof, may include an implementation of a networking environment.

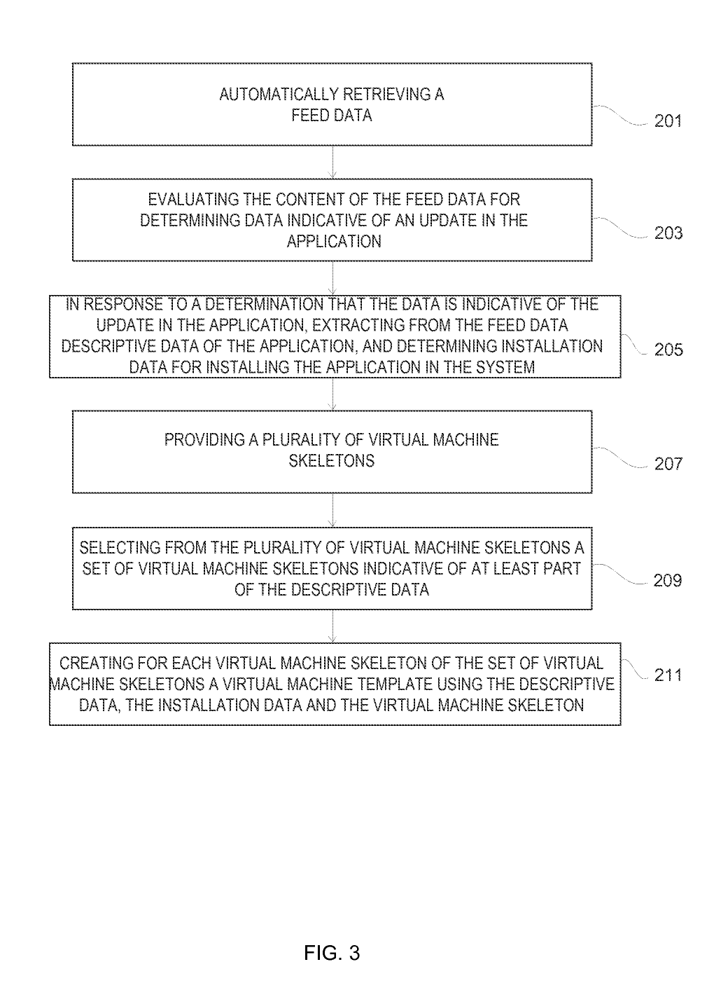

Program/utility 140 comprises a control module 143. The control module 143 can contain computer-executable code that enables the processor 116 to execute operations 201-211 of FIG. 3 and other operations described herein.

FIG. 3 is an example flowchart depicting operations for creating virtual machine templates in a system, the system hosting one or more applications to be executed on virtual machines of the system. The system may comprise the computer server 112.

In step 201, feed data is automatically retrieved from a server providing information on an application of the one or more applications.

In step 203, the content of the feed data is evaluated for determining data indicative of an update in the application.

In step 205, in response to a determination that the data is indicative of the update in the application, descriptive data of the application is extracted from the feed data, and installation data for installing the application in the system is determined.

In step 207, a plurality of virtual machine skeletons is provided. A skeleton defines the hardware and software configuration data of a virtual machine of the virtual machines.

In step 209, a set of virtual machine skeletons indicative of at least part of the descriptive data is selected from the plurality of virtual machine skeletons.

In step 211, for each virtual machine skeleton of the set of virtual machine skeletons a virtual machine template is created using the descriptive data, the installation data and the virtual machine skeleton.

What is claimed is:

1. A method comprising:
retrieving data from a data feed, wherein the data includes information about an application;
determining that the data from the data feed indicates that the application has been updated;
in response to said determining that the data from the data feed indicates that the application has been updated, extracting data descriptive of the application from the data from the data feed;
determining one or more instructions for installing the application based, at least in part, on the data descriptive of the application; and
in response to said determining the one or more instructions for installing the application, generating a first virtual machine skeleton that includes the one or more instructions for installing the application, wherein the first virtual machine skeleton defines the hardware and software configuration data of a first virtual machine.

2. The method of claim 1, wherein the application comprises one of an operating system and a software application.

3. The method of claim 1, wherein the data from the data feed comprises version data, wherein the version data comprises data indicating a latest version of the application.

4. The method of claim 3, wherein said determining that the data from the data feed indicates that the application has been updated comprises comparing the data indicating the latest version of the application with data indicating the version of the application that is installed on a second virtual machine based, at least in part, on a second virtual machine skeleton.

5. The method of claim 1, wherein said determining instructions for installing the application comprises determining configuration data and dependencies associated with the application.

6. The method of claim 1 further comprising:
creating the first virtual machine based, at least in part, on the first virtual machine skeleton; and
running the first virtual machine.

7. The method of claim 6, wherein said creating the first virtual machine based, at least in part, on the first virtual machine skeleton comprises:
creating a virtual machine template, wherein said creating the virtual machine template comprises executing the one or more instructions for installing the application; and
creating the first virtual machine based, at least in part, on the virtual machine template.

8. The method of claim 1 further comprising:
determining one or more virtual machine templates that include a previous version of the application; and
deleting the one or more virtual machine templates.
